(19) United States
(12) Patent Application Publication
(10) Pub. No.: US 2006/0132013 A1
(43) Pub. Date: Jun. 22, 2006

(54) Flat panel display having spacer and method of fixing spacer in flat panel display

(76) Inventor: Sung Hwan Jin, Suwon (KR)

Correspondence Address: CHRISTIE, PARKER & HALE, LLP, PO BOX 7068, PASADENA, CA, 91109-7068, US

(21) Appl. No.: 11/286,313

(22) Filed: Nov. 22, 2005

(30) Foreign Application Priority Data
Nov. 29, 2004 (KR) 2004-98751

(51) Int. Cl. H01J 19/42; H01J 63/04; H01J 1/88; H01J 9/24

(52) U.S. Cl. 313/292; 313/495; 445/24

(57) ABSTRACT

A flat panel display having a spacer and a method of fixing a spacer in a flat panel display are disclosed. The flat panel display includes: first and second substrates opposite to each other; and at least one spacer for supporting the first and second substrates to have a predetermined distance therebetween. The spacer includes a first surface facing the first substrate and a second surface facing the second substrate, and at least one of the first surface and the first substrate, and the second surface and the second substrate is adhered by an adhesive material containing tin (Sn) as a first element and at least one element selected from the group consisting of lead (Pb), silver (Ag), copper (Cu), antimony (Sb), and bismuth (Bi) as a second element.

### CROSS-REFERENCE TO RELATED APPLICATIONS

This application claims priority to and the benefit of Korean Patent Application No. 2004-98751, filed Nov. 29, 2004, the entire disclosure of which is hereby incorporated herein by reference.

### BACKGROUND

1. Field of the Invention

The present invention relates to a flat panel display having a spacer and to a method of fixing a spacer in a flat panel display and, more particularly, to a flat panel display which fixes a spacer to a structure using an adhesive material containing tin.

1. Discussion of Related Art

Displays are used to communicate information to human beings and have been employed as computer monitors, televisions, etc., but their applications are expanding. Displays are classified into two types: cathode ray tubes (CRT) and flat panel displays. A flat panel display can be a liquid crystal display (LCD), a plasma display, a fluorescent display, an electron emission display, etc.

One type of flat panel display is an electron emission display. In an electron emission display, an electron emission device is included, which uses either a hot cathode as an electron source or a cold cathode as an electron source. An electron emission device using the cold cathode as an electron source can be classified as a field emitter array (FEA) type, a surface conduction emitter (SCE) type, a metal-insulator-metal (MIM) type, a metal-insulator-semiconductor (MIS) type, a ballistic electron surface emitting (BSE) type, etc.

The electron emission display includes an electron emission region which has an electron emission device to emit electrons and an image forming region which collides the emitted electrons with a fluorescent layer to emit light. In general, the electron emission display includes a plurality of electron emission devices arranged on a first substrate, and a driving electrode for controlling the electron emission of the electron emission devices, and includes a fluorescent layer and an electrode connected to the fluorescent layer to allow the electrons emitted from the first substrate to be efficiently accelerated toward a fluorescent layer formed on a second substrate.

In the flat panel display, the first substrate and the second substrate are supported by spacers. In particular, the spacers are known as a very important element in the electron emission display. Hereinafter, the electron emission display will be explained as a representative example of the flat panel display.

Various methods of supporting the electron emission display using spacers, are known. For example, U.S. Pat. Nos. 5,811,927 and 6,042,445 disclose an exemplary method of supporting the electron emission display using spacers.

In U.S. Pat. No. 5,811,927, spacers are fixed to a substrate using a metal adhesive containing a gold (Au) grain. In U.S. Pat. No. 6,042,445, disclosed is a method of fixing the spacers to a substrate using an energy beam.

However, the method disclosed in U.S. Pat. No. 5,811,927 has disadvantages in that it uses high-priced gold (Au) and thus is not suitable for mass production and the manufactured electron emission display may be degraded because the bonding requires a heating process of at least 300° C. and a pressurizing process using a predetermined pressure.

Also, in the method of U.S. Pat. No. 6,042,445, the energy beam having high energy should be precisely controlled and thus high-priced equipment is required. Further, the disclosed method can be onerous in that the display should be designed such that the energy beam can pass through some of the electron emission display.

### SUMMARY OF THE INVENTION

Various embodiments of the present invention may solve one or more of the aforementioned problems associated with conventional displays by providing a flat panel display having a spacer with a new structure and a method of fixing the spacer.

In an exemplary embodiment of the present invention, a flat panel display includes: first and second substrates opposite to each other; and at least one spacer for supporting the first and second substrates to have a predetermined distance therebetween, wherein the spacer includes a first surface facing the first substrate and a second surface facing the second substrate, and at least one of the first surface and the first substrate, and the second surface and the second substrate are coupled together by an adhesive material containing tin (Sn) as a first element and at least one element selected from the group consisting of lead (Pb), silver (Ag), copper (Cu), antimony (Sb), and bismuth (Bi) as a second element.

When the spacer is coupled to the first substrate and/or the second substrate, the spacer may be arranged on a structure formed on the substrate, or the spacer may be directly arranged on the substrate. Thus, “the substrate facing the spacer” may mean that any type of structures may be added between the spacer and the substrate. Here, “structure” is a general name of various insulating layers and various metal layers which are required in manufacturing the flat panel display. For example, when the spacer directly contacts a mesh electrode structure, “structure” means a mesh electrode structure.

The adhesive material may contain tin (Sn) as a first element (main element) and at least one element selected from the group consisting of lead (Pb), silver (Ag), copper (Cu), antimony (Sb), and bismuth (Bi) as a second element.

If needed, polymer alcohol, resin, etc. may be added to the adhesive material by 5 to 10% or less than 5% to improve adhesion.

The adhesive material containing tin (Sn) and lead (Pb) may melt at various meting points from low temperature to high temperature according to content of lead (Pb). For example, when the adhesive material is made by mixing 31% to 33% of lead, 54% to 57% of tin (Sn), and 4% to 7% of resin, a melting temperature may be in a range of 183° C. to 236° C. When the adhesive material is made by mixing 31% to 33% of lead, 54% to 57% of tin (Sn), 1.8% of silver (Ag), and 4% to 7% of resin, a melting temperature may be in a range of 179° C. to 235° C. The adhesive material may be usefully applied to a manufacturing process of the flat panel display which requires a low temperature process of less than 250° C. Therefore, the adhesive material containing these elements has a melting point of less than 250° C.

When the adhesive material containing tin (Sn) is 96.5Sn/3.0Ag/0.5Cu, a melting point may be 220° C., and in the case of 95.5Sn/4.0Ag/0.5Cu, a melting point may be less than about 250° C., whereby it may be usefully employed to the flat panel display. Copper (Cu) may have a content of less than 15%, and would likely be unsuitable. The adhesive material containing tin (Sn), antimony (Sb) and bismuth (Bi) may be fused at a temperature of about 140° C.

A metal layer may be arranged on the first surface and/or the second surface or a metal layer may be added on surfaces of structures of the first and second substrates, facing the spacer. Such a structure may improve adhesion of the adhesive material. The adhesive material may have a thickness of 10 μm to 50 μm. The metal layer may contain nickel (Ni) or copper (Cu). Tin and nickel, and tin and copper may be coupled by a strong bonding force. The metal layer may have a thickness of 0.5 μm to 1 μm. When the flat panel display is an electron emission display, a fluorescent layer with which the emitted electrons collide may be provided. Since the characteristics of the fluorescent layer may be degraded due to a copper element, nickel may be used as the metal layer.

In another exemplary embodiment of the present invention, a method of fixing a spacer in a flat panel display including first and second substrates opposite to each other, and at least one spacer for supporting the first and second substrates to have a predetermined distance therebetween, wherein the spacer includes a first surface facing the first substrate and a second surface facing the second substrate, the method includes: providing an adhesive material containing tin (Sn) as a first element and at least one element selected from the group consisting of lead (Pb), silver (Ag), copper (Cu), antimony (Sb), and bismuth (Bi) as a second element, arranging the adhesive material between at least one of the first surface and the first substrate and the second surface and the second substrate, and heating the adhesive material.

It is possible to form the adhesive material such that it is smaller than an area taken up by the spacer or such that a certain portion is spread to be larger than an area of the spacer. For example, several solder pastes may be arranged on the contact area of the spacer in the form of a bump.

In some embodiments, the heating may be performed at temperatures of less than 250° C. at a predetermined pressure. The arrangement of the solder pastes may be performed by coating them by a printing method. In general, the temperature of less than 250° C. does not affect the characteristics of the flat panel display, and thus such heating makes it possible to manufacture a reliable flat panel display.

### BRIEF DESCRIPTION OF THE DRAWINGS

FIG. 1 is a schematic cross-sectional view of a portion of a flat panel display according to a first embodiment of the present invention.

FIG. 2 is a schematic cross-sectional view of a portion of a flat panel display according to a second embodiment of the present invention.

FIG. 3 is a plan view of an electron emission display according to the embodiment shown in FIG. 2, focusing on arrangement of the spacer.

### DETAILED DESCRIPTION

The present invention will now be described more fully hereinafter with reference to the accompanying drawings, in which embodiments of the invention are shown.

### FIRST EMBODIMENT

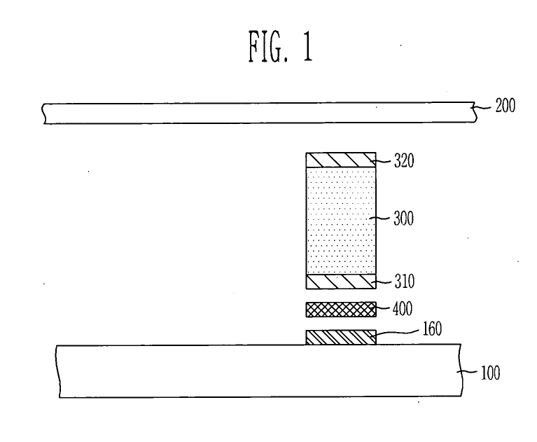

FIG. 1 is schematic cross-sectional view of a portion of a flat panel display according to a first embodiment of the present invention.

Referring to FIG. 1, the flat panel display includes first and second substrates 100 and 200 opposite to each other, and at least one spacer 300 which supports the first and second substrates 100 and 200 to have a predetermined distance therebetween. The spacer 300 has a first surface facing the first substrate 100 and a second surface facing the second substrate 200, and the first and second surfaces have metal layers 310 and 320, respectively.

An adhesive material 400 containing tin (Sn) is interposed between the first substrate 100 and the spacer 300 to adhere the spacer 300 to the first substrate 100. FIG. 1 shows that a metal layer 160 is additionally formed between the first substrate 100 and the adhesive material 400.

The first and second substrates 100 and 200 may be made of a material such as glass or glass containing reduced impurity such as Sodium (Na), and, a ceramic substrate, a plastic substrate, and/or a silicon substrate which has a SiO₂ layer as an insulating layer may be used as the first and second substrates 100 and 200.

As the metal layers 310 and 320, a metal such as Cr, Al, Mo, Cu, Ni, and Au may be formed to a thickness of 0.5 μm to 1 μm using a typical deposition technique. In one embodiment, a metal which is excellent in adhesion with the metal is employed in the adhesive material. Thus, when the metal layers 310 and 320 are made of metals containing nickel or copper, tin and nickel or tin and copper can be coupled by strong bonding force.

The spacer 300 may be made of a material which is suitable for supporting the first and second substrates 100 and 200 and thus the spacer material is not limited to a special material and can be various materials. If needed, the spacer material may require a sufficient insulating property. In such instance, the spacer may be made of quartz glass, glass containing sodium ingredient, soda-lime glass, alumina, or ceramic containing alumina. In one embodiment, a thermal expansion coefficient of the spacer 300 is a value close to those of the first and second substrates 100 and 200.

As the adhesive material 400, an adhesive material containing tin is coated, at a location to which the spacer 300 is loaded, to a predetermined thickness using a printing technique, and the spacer 300 is arranged on the adhesive material 400. The adhesive material 400 contains tin (Sn) as a first element and at least one selected from a group consisting of lead (Pb), silver (Ag), copper (Cu), antimony (Sb), and bismuth (Bi) as a second element. For example, when the adhesive material 400 contains tin (Sn) and lead (Pb), the adhesive material 400 is made by mixing 31 to 33% of lead (Pb), 54 to 57% of tin (Sn), and 4 to 7% of resin. In this case, the adhesive material 400 has a melting temperature of 183° C. to 236° C., and thus it may melt even at a low temperature of less than about 250° C. to fix the spacer. That is, the adhesive material 400 is heated at a temperature of less than about 250° C., and the spacer 300 and the first substrate 100 are pressurized at a predetermined pressure. Through the above-described process, the spacer 300 is fixed by the adhesive material 400. In one embodiment, the adhesive material 400 has a thickness of 10 μm to 50 μm. The adhesive material 400 may additionally contain resin, polymer alcohol, polymerized resin, etc.

### SECOND EMBODIMENT

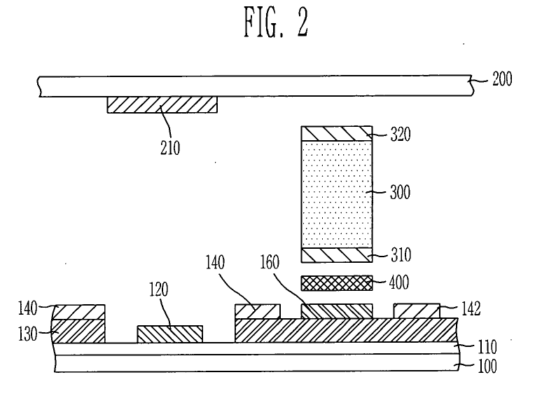

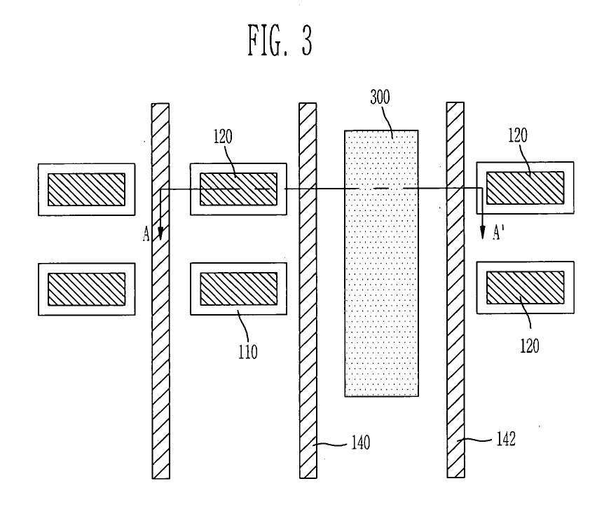

FIG. 2 is a schematic cross-sectional view of a portion of a flat panel display according to a second embodiment of the present invention. FIG. 3 is a plan view of the electron emission display according to the second embodiment of the present invention, focusing on arrangement of the spacer. FIG. 2 is a cross-sectional view taken along the line A-A′ in FIG. 3.

Referring to FIGS. 2 and 3, the electron emission display includes first and second substrates 100 and 200 opposite to each other, and at least one spacer 300 which supports the first and second substrates 100 and 200 to have a predetermined distance therebetween.

A first electrode 110 having a predetermined shape, second electrodes 140 and 142 arranged to be insulated from the first electrode 110, and an electron emission portion 120 connected to the first electrode 1 10 are formed on the first substrate 100. The electron emission portion 120 is connected to the first electrode 110, and electrons are emitted from the electron emission portion 120 due to a difference between voltages applied to these electrodes 110, 140 and 142. An insulating layer 130 is formed to a thickness of several nanometers to tens of micrometers using a typical insulating layer forming method such as a screen printing method, a sputtering method, a chemical vapor deposition method, and a vacuum deposition method. The insulating layer 130 may be formed of SiO₂ or SiNx. The second electrodes 140 and 142 are lines adjacent to each other and configured to respectively receive independent signals.

The electron emission portion 120 may be made of a carbon-based material such as metal-tip, graphite, diamond, diamond-like carbon or combination thereof, or a nano-size material such as nano tube or nano wire.

FIGS. 2 and 3 show a structure that the first and second electrodes are separated from each other with the insulating layer interposed therebetween, but the structure of these electrodes is not limited to this but can be changed diversely according to a desired electron emission function.

The second substrate 200 includes a fluorescent layer 210 having a stripe shape. Electrons emitted from the electron emission portion 120 collide with the fluorescent layer so that light is emitted. In such instance, an anode electrode (not shown) may be added to accelerate the electrons. The anode electrode may include a one-body type electrode, a stripe type electrode or a split type electrode, and the fluorescent layer may have a stripe or dot shape. A light shielding layer may be additionally formed on portions between the fluorescent layers 210 to prevent different colors of light from being emitted.

An adhesive material 400 of the electron emission display is interposed between a metal layer 310 formed on a bottom surface of a spacer 300 and a metal layer 160 formed on the first substrate 100 to adhere the spacer 300.

FIGS. 2 and 3 show that the metal layer 160 is formed only below the spacer 300, but the metal layer 160 may be alternatively configured to play a role of an auxiliary electrode. If playing the role of an auxiliary electrode, a voltage different from that applied to the first and second electrodes 110 and 140 can be applied to the spacer. Thus, in addition to a role capable of improving adhesion when the spacer 300 is fixed, the metal layer 160 is configured to apply a separate power voltage to the spacer 300, thereby mitigating a phenomenon that charges are charged to the spacer.

As described above, the metal layer 160 in an exemplary embodiment is a layer containing nickel or copper. This is because tin and nickel or tin and copper belonging to the adhesive material can be coupled to have a strong bonding force. In one embodiment, the metal layer has a thickness of 0.5 μm to 1 μm.

When it is applied to the electron emission display, the electron emission display has a fluorescent layer with which electrons collide. In such instance, characteristics of the fluorescent layer may be degraded due to the copper element, and thus use of nickel may improve these characteristics.

As described herein before, various embodiments of the present invention may have one or more of the following advantages.

First, the adhesive material containing tin (Sn) can be heated in some embodiments at a low temperature to be adhered. When a metal adhesive containing gold (Au) grains is used, minimum 300° C. is needed, whereas when an adhesive material containing tin (Sn) is used as shown in some embodiments, the spacer may be adhered stably and reliably, even at a temperature of less than 250° C.

Second, since a high-priced material such as gold (Au) is not used in these embodiments, a high quality flat panel display can be manufactured at low cost.

Third, in an electron emission display, a region on which the spacer is arranged is prepared between the electrodes, and thus it is narrow. Therefore, when the adhesive material is arranged on a region other than a region on which the spacer is arranged, a short circuit may occur. According to some embodiments shown in FIGS. 1-3, such a short circuit can be prevented.

Fourth, since the spacer is fixed in the described embodiments using an adhesive material containing tin (Sn), adhesive strength and electrical conductivity are excellent.

Fifth, in some embodiments an adhesive material containing not lead (Pb) but tin (Sn) is used, so better eco-friendly products can be manufactured.

Although the present invention has been described with reference to certain exemplary embodiments thereof, it will be understood by those skilled in the art that a variety of modifications and variations may be made to the present invention without departing from the spirit or scope of the present invention, as defined in the appended claims, and their equivalents.

What is claimed is:

1. A flat panel display comprising:
a first substrate and second substrate opposite to each other; and
a spacer for supporting the first and the second substrate to have a predetermined distance therebetween,
wherein the spacer includes a first surface facing the first substrate and a second surface facing the second substrate, and
wherein at least one of the first surface and the first substrate, and the second surface and the second substrate are coupled together by an adhesive material containing tin as a first element and at least one element selected from the group consisting of lead, silver, copper, antimony, and bismuth as a second element.

2. The display according to claim 1, wherein the adhesive material contains tin and lead.

3. The display according to claim 1, wherein the adhesive material contains tin, silver and copper.

4. The display according to claim 1, wherein a metal layer is arranged on at least one of the first surface and the second surface.

5. The display according to claim 1, further comprising a metal layer coupled to at least one of the first and second substrates, facing the spacer.

6. The display according to claim 4, wherein the metal layer contains nickel or copper.

7. The display according to claim 6, wherein the metal layer contains nickel.

8. The display according to claim 5, wherein the metal layer contains nickel or copper.

9. The display according to claim 8, wherein the metal layer contains nickel.

10. The display according to claim 4, wherein the metal layer has a thickness of 0.5 μm to 1 μm.

11. The display according to claim 5, wherein the metal layer has a thickness of 0.5 μm to 1 μm.

12. The display according to claim 1, wherein the adhesive material has a thickness of 10 μm to 50 μm.

13. The display according to claim 1, wherein the display is an electron emission display.

14. A method of fixing a spacer in a flat panel display including a first substrate and a second substrate opposite to each other; and at least one spacer for supporting the first substrate and the second substrate to have a predetermined distance therebetween, the spacer including a first surface facing the first substrate and a second surface facing the second substrate, the method comprising:
providing an adhesive material containing tin as a first element and at least one element selected from the group consisting of lead, silver, copper, antimony, and bismuth as a second element;
arranging the adhesive material between at least one of the first surface and the first substrate, and the second surface and the second substrate; and
heating the adhesive material.

15. The method of claim 14, wherein the heating is performed at a temperature of less than 250° C.

16. The method of claim 14, wherein the heating is performed at a temperature of about 140° C.

17. The method of claim 14, wherein the arranging comprises coating the adhesive material by a printing method.

18. The method of claim 14, wherein the adhesive material contains tin and lead.

19. The method of claim 14, wherein the adhesive material contains tin, silver and copper.

20. The method of claim 14, further comprising arranging a metal layer between the spacer and at least one of the first or second substrates.
